(19) United States
(12) Patent Application Publication
(10) Pub. No.: US 2026/0055213 A1
(43) Pub. Date: Feb. 26, 2026

(54) MULTIMODAL POLYMERIZATION PROCESSES WITH MULTI-CATALYST SYSTEMS

(71) Applicant: Dow Global Technologies LLC, Midland, MI (US)

(72) Inventors: Philip P. Fontaine, Pearland, TX (US); Jerzy Klosin, Midland, MI (US); Mari S. Rosen, Houston, TX (US)

(73) Assignee: Dow Global Technologies LLC, Midland, MI (US)

(21) Appl. No.: 19/105,629

(22) PCT Filed: Aug. 29, 2023
(86) PCT No.: PCT/US2023/073085

§ 371 Date: Feb. 21, 2025

Related U.S. Application Data
(60) Provisional application No. 63/401,909, filed on Aug. 29, 2022.
(60) Provisional application No. 63/516,725, filed on Jul. 31, 2023.

(51) Int. Cl. C08F 4/6592; C08F 2/04; C08F 4/659; C08F 210/16

(52) U.S. Cl. CPC C08F 4/6592; C08F 2/04; C08F 210/16; C08F 4/65908; C08F 4/65912; C08F 2420/01; C08F 2420/03

(57) ABSTRACT

This disclosure is directed to processes of polymerizing olefin monomers to produce polyolefin. The processes include reacting ethylene and optionally one or more olefin monomers in one or multiple reactors in the presence of a catalyst system. The catalyst system includes two or more catalysts, at least one of which is derived from constrained geometry procatalyst according to formula (I) and at least one of which is derived from phosphinimine procatalyst according to formula (V): (I) (V).

### CROSS-REFERENCE TO RELATED APPLICATIONS

This application claims priority to U.S. Provisional Application No. 63/401,909 filed Aug. 29, 2022, and U.S. Provisional Application No. 63/516,725, filed Jul. 31, 2023, the entireties of which are incorporated by reference herein.

### TECHNICAL FIELD

Embodiments of the present disclosure generally relate to olefin polymerization catalyst systems and processes, and, more specifically, to the olefin polymerization catalyst systems including one or more constrain geometry procatalysts and one or more phosphinimine procatalysts and polymerization processes incorporating the catalyst systems to produce bimodal polymers.

### BACKGROUND

Olefin-based polymers such as polyethylene, ethylene-based polymers, polypropylene, and propylene-based polymers are produced via various catalyst systems. Selection of such catalyst systems used in the polymerization process of the olefin-based polymers is an important factor contributing to the characteristics and properties of such olefin-based polymers.

Ethylene-based polymers and propylene-based are manufactured for a wide variety of articles. The polyethylene and polypropylene polymerization process can be varied in a number of respects to produce a wide variety of resultant polyethylene resins having different physical properties that render the various resins suitable for use in different applications. The ethylene monomers and, optionally, one or more co-monomers are present in liquid diluents (such as solvents), such as an alkane or isoalkane, for example isobutene. Hydrogen may also be added to the reactor. The catalyst systems for producing ethylene-based may typically comprise a chromium-based catalyst system, a Ziegler-Natta catalyst system, and/or a molecular (either metallocene or non-metallocene (molecular)) catalyst system. The reactants in the diluent and the catalyst system are circulated at an elevated polymerization temperature around the reactor, thereby producing ethylene-based homopolymer or copolymer. Either periodically or continuously, part of the reaction mixture, including the polyethylene product dissolved in the diluent, together with unreacted ethylene and one or more optional co-monomers, is removed from the reactor. The reaction mixture, when removed from the reactor, may be processed to remove the polyethylene product from the diluent and the unreacted reactants, with the diluent and unreacted reactants typically being recycled back into the reactor. Alternatively, the reaction mixture may be sent to a second reactor, serially connected to the first reactor, where a second polyethylene fraction may be produced. Despite the research efforts in developing catalyst systems suitable for olefin polymerization, such as polyethylene or polypropylene polymerization, there is still a need to increase the efficiencies of catalyst systems that are capable of producing polymer with high molecular weights and a narrow molecular weight distribution.

### SUMMARY

Ongoing needs exist to produce a multimodal polyethylene polymer. Specifically, synthesizing LLDPE resins using a flexible catalyst system that is compatible with high temperature solution processes.

By combining catalysts derived from two different classes—constrained geometry metal-ligand complexes (CGC catalysts) and phosphinimide complexes (PN catalysts)—the advantages of the different properties of the catalysts can be used to make the multimodal polyethylene resin.

The molecular weight of the polymer produced by PN catalysts is much more sensitive to hydrogen than is the molecular weight of the polymer produced by CGC catalysts. Consequently, the molecular weight split (difference in molecular weight of the polyethylene produced by the two catalysts) can be easily tailored by adjusting hydrogen levels without significantly changing other conditions. The small changes in the hydrogen level results in large differences in molecular weight of the polymer produced by the PN catalyst. Comparatively, the same increases in H₂ lead to smaller changes in the polymer produced by the CGC catalyst. FIGS. 1A, 1B, and 1C illustrate the changes in molecular weight of the polyethylene produced CGC catalysts and the PN catalysts.

Embodiments of this disclosure include processes of polymerizing olefin monomers to produce polyolefin. The process includes reacting ethylene and optionally one or more olefin monomers in one reactor or multiple reactors in the presence of a catalyst system and optionally hydrogen gas. The catalyst comprises two or more catalysts, at least one of which is derived from constrained geometry procatalyst according to formula (I) and at least one of which is derived from phosphinimine procatalyst according to formula (V). The amount of hydrogen gas may be adjusted to tailor the molecular weight of the polyolefin.

Formula (I) and formula (V) have structure according to:

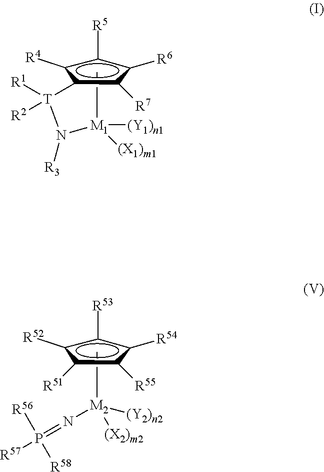

In formula (I) and formula (V), each X₁ and X₂ is a monodentate ligand independently chosen from (C₁-C₅₀)hydrocarbyl, (C₁-C₅₀)heterohydrocarbyl, —CH₂Si(R^{C})_{3-Q}(OR^{C})_{Q}, —Si(R^{C})_{3-Q}(OR^{C})_{Q}, —OSi(R^{C})_{3-Q}(OR^{C})_{Q}, —CH₂Ge(R^{C})_{3-Q}(OR^{C})_{Q}, —Ge(R^{C})_{3-Q}(OR^{C})_{Q}, —P(R^{C})_{2-W}(OR^{C})_{W}, —P(O)(R^{C})_{2-W}(OR^{C})_{W}, —N(R^{C})₂, —NH(R^{C}), —N(Si(R^{C})₃)₂, —NR^{C}Si(R^{C})₃—NHSi(R^{C})₃, —OR^{C}, —SR^{C}, —NO₂, —CN, —CF₃, —OCF₃, —S(O)R^{C}, —S(O)₂R^{C}, —OS(O)₂R^{C}, —N═C(R^{C})₂, —N═CH(R^{C}), —N═CH₂, —N═P(R^{C})₃, —OC(O)R^{C}, —C(O)OR^{C}, —N(R^{C})C(O)R^{C}, —N(R^{C})C(O)H, —NHC(O)R^{C}, —C(O)N(R^{C})₂, —C(O)NHR^{C}, —C(O)NH₂, a halogen, B(R^{Y})₄, Al(R^{Y})₄, or Ga(R^{Y})₄, or a hydrogen, wherein each R^{C} is independently a (C₁-C₃₀)hydrocarbyl, or (C₁-C₃₀)heterohydrocarbyl, and each Q is 0, 1, 2 or 3, and each W is 0, 1, or 2; each R^{Y} is —H, (C₁-C₃₀)hydrocarbyl, or halogen atom, wherein two X₁ ligands can be connected to form a metallacycle ring; and wherein two X₂ ligands can be connected to form a metallacycle ring.

In formula (I) and formula (V), each Y₁ and Y₂ is independently Lewis Base; optionally, X₁ and Y₁ can be linked to form a ring; optionally, X₂ and Y₂ can be linked to form a ring.

In formula (I) and formula (V), each subscript m₁ and m₂ is 1 or 2; and each subscript n₁ and n₂ is 0, 1 and 2. The metal-ligand complex is overall charge-neutral;

In formula (I), M₁ is titanium, zirconium, hafnium, or scandium. In formula (I), N is nitrogen; T is carbon, silicon or germanium. R¹ and R² are independently selected from —H, (C₁-C₄₀)hydrocarbyl, and (C₁-C₄₀)heterohydrocarbyl; R³ are independently selected from (C₁-C₄₀)hydrocarbyl, and (C₁-C₄₀)heterohydrocarbyl.

In formula (V), M₂ is titanium, zirconium, or hafnium; R⁵¹, R⁵², R⁵³, R⁵⁴, and R⁵⁵ are independently (C₁-C₅₀)hydrocarbyl, (C₁-C₅₀)heterohydrocarbyl wherein any of the R⁵², R⁵³, R⁵⁴, and R⁵⁵ optionally are connected to form a ring structure; R⁵⁶, R⁵⁷, and R⁵⁸ are independently (C₁-C₂₀)hydrocarbyl, (C₁-C₂₀)heterohydrocarbyl, (C₆-C₃₀)aryl, (C₅-C₃₀)heteroaryl wherein two of R⁵⁶, R⁵⁷, and R⁵⁸ are optionally connected to form a ring; and

### BRIEF DESCRIPTION OF FIGURES

FIG. 1A shows two theoretical molecular weight distribution curves of two unimodal polymer compositions produced by a constrained geometry catalyst and produced by a phosphinimine catalyst with no hydrogen gas in the reactor chamber.

FIG. 1B shows two theoretical molecular weight distribution curves of two unimodal polymer compositions produced by a constrained geometry catalyst and produced by a phosphinimine catalyst with a small amount of hydrogen gas in the reactor chamber.

FIG. 1C shows two theoretical molecular weight distribution curves of two unimodal polymer compositions produced by a constrained geometry catalyst and produced by a phosphinimine catalyst with a larger amount of hydrogen gas in the reactor chamber.

FIG. 2 is a graph of the molecular weight of polymers produced by three different phosphinimine catalysts as a function of the amount of hydrogen (mmol) in the reactor.

FIG. 3 is molecular weight distribution curve of bimodal polymer compositions produced by a CGC-1 and a PN-1 with varying amounts of hydrogen gas in the reactor chamber. These amounts of hydrogen gas are 0 mmol, 5 mmol, 20 mmol, and 40 mmol.

### DETAILED DESCRIPTION

Specific embodiments of catalyst systems will now be described. It should be understood that the catalyst systems of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

The term “independently selected” followed by multiple options is used herein to indicate that individual R groups appearing before the term, such as R¹, R², R³, R⁴, and R⁵, can be identical or different, without dependency on the identity of any other group also appearing before the term.

The term “procatalyst” refers to a compound that has catalytic activity when combined with an activator. The term “activator” refers to a compound that chemically reacts with a procatalyst in a manner that converts the procatalyst to a catalytically active catalyst. As used herein, the terms “co-catalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₅₀)alkyl is an alkyl group having from 1 to 50 carbon atoms in its unsubstituted form. In some embodiments and general structures, certain chemical groups may be substituted by one or more substituents such as R^{S}. An R^{S} substituted version of a chemical group defined using the “(Cₓ-C_{y})” parenthetical may contain more than y carbon atoms depending on the identity of any groups R^{S}. For example, a “(C₁-C₅₀)alkyl substituted with exactly one group R^{S}, where R^{S} is phenyl (—C₆H₅)” may contain from 7 to 56 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom or heteroatom of a corresponding unsubstituted compound or functional group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent. The term “—H” means a hydrogen or hydrogen radical that is covalently bonded to another atom. “Hydrogen” and “—H” are interchangeable, and unless clearly specified have identical meanings.

The term “(C₁-C₅₀)hydrocarbyl” means a hydrocarbon radical of from 1 to 50 carbon atoms and the term “(C₁-C₅₀)hydrocarbylene” means a hydrocarbon diradical of from 1 to 50 carbon atoms, in which each hydrocarbon radical and each hydrocarbon diradical is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S} or unsubstituted.

In this disclosure, a (C₁-C₅₀)hydrocarbyl may be an unsubstituted or substituted (C₁-C₅₀)alkyl, (C₃-C₅₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene (such as benzyl (—CH₂-C₆H₅)).

The terms “(C₁-C₅₀)alkyl” and “(C₁-C₁₈)alkyl” mean a saturated straight or branched hydrocarbon radical of from 1 to 50 carbon atoms and a saturated straight or branched hydrocarbon radical of from 1 to 18 carbon atoms, respectively, that is unsubstituted or substituted by one or more R^{S}. Examples of unsubstituted (C₁-C₅₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅]alkyl. The term “[C₄₅]alkyl” means there is a maximum of 45 carbon atoms in the radical, including substituents, and is, for example, a (C₂₇-C₄₀)alkyl substituted by one R^{S}, which is a (C₁-C₅)alkyl, respectively. Each (C₁-C₅)alkyl may be methyl, trifluoromethyl, ethyl, 1-propyl, 1-methylethyl, or 1,1-dimethylethyl.

The term “(C₆-C₅₀)aryl” means an unsubstituted or substituted (by one or more R^{S}) mono-, bi- or tricyclic aromatic hydrocarbon radical of from 6 to 40 carbon atoms, of which at least from 6 to 14 of the carbon atoms are aromatic ring carbon atoms. A monocyclic aromatic hydrocarbon radical includes one aromatic ring; a bicyclic aromatic hydrocarbon radical has two rings; and a tricyclic aromatic hydrocarbon radical has three rings. When the bicyclic or tricyclyc aromatic hydrocarbon radical is present, at least one of the rings of the radical is aromatic. The other ring or rings of the aromatic radical may be independently fused or non-fused and aromatic or non-aromatic. Examples of unsubstituted (C₆-C₅₀)aryl include: unsubstituted (C₆-C₂₀)aryl, unsubstituted (C₆-C₁₈)aryl; 2-(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₄₀)aryl include: substituted (C₁-C₂₀)aryl; substituted (C₆-C₁₈)aryl; 2,4-bis([C₂₀]alkyl)-phenyl; polyfluorophenyl; pentafluorophenyl; and fluoren-9-one-1-yl.

The term “(C₃-C₅₀)cycloalkyl” means a saturated cyclic hydrocarbon radical of from 3 to 50 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl, cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl, cyclopentanon-2-yl, and 1-fluorocyclohexyl.

Examples of (C₁-C₅₀)hydrocarbylene include unsubstituted or substituted (C₆-C₅₀)arylene, (C₃-C₅₀)cycloalkylene, and (C₁-C₅₀)alkylene (e.g., (C₁-C₂₀)alkylene). The diradicals may be on the same carbon atom (e.g., —CH₂—) or on adjacent carbon atoms (i.e., 1,2-diradicals), or are spaced apart by one, two, or more than two intervening carbon atoms (e.g., 1,3-diradicals, 1,4-diradicals, etc.). Some diradicals include 1,2-, 1,3-, 1,4-, or an α,ω-diradical, and others a 1,2-diradical. The α,ω-diradical is a diradical that has maximum carbon backbone spacing between the radical carbons. Some examples of (C₂-C₂₀)alkylene α,ω-diradicals include ethan-1,2-diyl (i.e. —CH₂CH₂—), propan-1,3-diyl (i.e. —CH₂CH₂CH₂—), 2-methylpropan-1,3-diyl (i.e. —CH₂CH(CH₃)CH₂—). Some examples of (C₆-C₅₀)arylene α,ω-diradicals include phenyl-1,4-diyl, napthalen-2,6-diyl, or napthalen-3,7-diyl.

The term “(C₁-C₅₀)alkylene” means a saturated straight chain or branched chain diradical (i.e., the radicals are not on ring atoms) of from 1 to 50 carbon atoms that is unsubstituted or substituted by one or more R^{S}. Examples of unsubstituted (C₁-C₅₀)alkylene are unsubstituted (C₁-C₂₀)alkylene, including unsubstituted —CH₂CH₂—, —(CH₂)₃—, —(CH₂)₄—, —(CH₂)₅—, —(CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical. Examples of substituted (C₁-C₅₀)alkylene are substituted (C₁-C₂₀)alkylene, —CF₂—, —C(O)—, and —(CH₂)₁₄C(CH₃)₂(CH₂)₅— (i.e., a 6,6-dimethyl substituted normal-1,20-eicosylene). Since as mentioned previously two R^{S} may be taken together to form a (C₁-C₁₈)alkylene, examples of substituted (C₁-C₅₀)alkylene also include 1,2-bis(methylene)cyclopentane, 1,2-bis(methylene)cyclohexane, 2,3-bis(methylene)-7,7-dimethyl-bicyclo[2.2.1]heptane, and 2,3-bis(methylene)bicyclo [2.2.2]octane.

The term “(C₃-C₅₀)cycloalkylene” means a cyclic diradical (i.e., the radicals are on ring atoms) of from 3 to 50 carbon atoms that is unsubstituted or substituted by one or more R^{S}.

The term “heteroatom,” refers to an atom other than hydrogen or carbon. Examples of groups containing one or more than one heteroatom include O, S, S(O), S(O)₂, Si(R^{C})₂, P(R^{P}), N(R^{N}), —N═C(R^{C})₂, —Ge(R^{C})₂—, or —Si(R^{C})—, where each R^{C} and each R^{P} is unsubstituted (C₁-C₁₈)hydrocarbyl or —H, and where each R^{N} is unsubstituted (C₁-C₁₈)hydrocarbyl. The term “heterohydrocarbon” refers to a molecule or molecular framework in which one or more carbon atoms of a hydrocarbon are replaced with a heteroatom. The term “(C₁-C₅₀)heterohydrocarbyl” means a heterohydrocarbon radical of from 1 to 50 carbon atoms, and the term “(C₁-C₅₀)heterohydrocarbylene” means a heterohydrocarbon diradical of from 1 to 50 carbon atoms. The heterohydrocarbon of the (C₁-C₅₀)heterohydrocarbyl or the (C₁-C₅₀)heterohydrocarbylene has one or more heteroatoms. The radical of the heterohydrocarbyl may be on a carbon atom or a heteroatom. The two radicals of the heterohydrocarbylene may be on a single carbon atom or on a single heteroatom. Additionally, one of the two radicals of the diradical may be on a carbon atom and the other radical may be on a different carbon atom; one of the two radicals may be on a carbon atom and the other on a heteroatom; or one of the two radicals may be on a heteroatom and the ofther radical on a different heteroatom. Each (C₁-C₅₀)heterohydrocarbyl and (C₁-C₅₀)heterohydrocarbylene may be unsubstituted or substituted (by one or more R^{S}), aromatic or non-aromatic, saturated or unsaturated, straight chain or branched chain, cyclic (including mono- and poly-cyclic, fused and non-fused polycyclic), or acyclic.

The (C₁-C₅₀)heterohydrocarbyl may be unsubstituted or substituted. Non-limiting examples of the (C₁-C₅₀)heterohydrocarbyl include (C₁-C₅₀)heteroalkyl, (C₁-C₅₀)hydrocarbyl-O—, (C₁-C₅₀)hydrocarbyl-S—, (C₁-C₅₀)hydrocarbyl-S(O)—, (C₁-C₅₀)hydrocarbyl-S(O)₂—, (C₁-C₅₀)hydrocarbyl-Si(R^{C})₂—, (C₁-C₅₀)hydrocarbyl-N(R^{N})—, (C₁-C₅₀)hydrocarbyl-P(R)—, (C₂-C₅₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂₀)heteroalkylene, (C₁-C₅₀)heteroaryl, (C₁-C₁₉)heteroaryl-(C₁-C₂₀)alkylene, (C₁-C₂₀)aryl-(C₁-C₁₉)heteroalkylene, or (C₁-C₁₉)heteroaryl-(C₁-C₂₀)heteroalkylene.

The term “(C₄-C₅₀)heteroaryl” means an unsubstituted or substituted (by one or more R^{S}) mono-, bi-, or tricyclic heteroaromatic hydrocarbon radical of from 4 to 50 total carbon atoms and from 1 to 10 heteroatoms. A monocyclic heteroaromatic hydrocarbon radical includes one heteroaromatic ring; a bicyclic heteroaromatic hydrocarbon radical has two rings; and a tricyclic heteroaromatic hydrocarbon radical has three rings. When the bicyclic or tricyclyc heteroaromatic hydrocarbon radical is present, at least one of the rings in the radical is heteroaromatic. The other ring or rings of the heteroaromatic radical may be independently fused or non-fused and aromatic or non-aromatic. Other heteroaryl groups (e.g., (Cₓ-C_{y})heteroaryl generally, such as (C₄-C₁₂)heteroaryl) are defined in an analogous manner as having from x to y carbon atoms (such as 4 to 12 carbon atoms) and being unsubstituted or substituted by one or more than one R^{S}. The monocyclic heteroaromatic hydrocarbon radical is a 5-membered ring or a 6-membered ring. The 5-membered ring has 5 minus h carbon atoms, wherein h is the number of heteroatoms and may be 1, 2, or 3; and each heteroatom may be O, S, N, or P. Examples of 5-membered ring heteroaromatic hydrocarbon radicals include pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring has 6 minus h carbon atoms, wherein h is the number of heteroatoms and may be 1 or 2 and the heteroatoms may be N or P. Examples of 6-membered ring heteroaromatic hydrocarbon radicals include pyridine-2-yl; pyrimidin-2-yl; and pyrazin-2-yl. The bicyclic heteroaromatic hydrocarbon radical can be a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo[3,2-f]indol-1-yl. An example of the fused 5,6,6-ring system is 1H-benzo[f]indol-1-yl. An example of the fused 6,5,6-ring system is 9H-carbazol-9-yl. An example of the fused 6,5,6-ring system is 9H-carbazol-9-yl. An example of the fused 6,6,6-ring system is acrydin-9-yl.

The term “(C₁-C₅₀)heteroalkyl” means a saturated straight or branched chain radicals containing one to fifty carbon atoms, or fewer carbon atoms and one or more of the heteroatoms. The term “(C₁-C₅₀)heteroalkylene” means a saturated straight or branched chain diradicals containing from 1 to 50 carbon atoms and one or more than one heteroatoms. The heteroatoms of the heteroalkyls or the heteroalkylenes may include Si(R^{C})₃, Ge(R^{C})₃, Si(R^{C})₂, Ge(R^{C})₂, P(R^{P})₂, P(R^{P}), N(R^{N})₂, N(R^{N}), N, O, OR^{C}, S, SR^{C}, S(O), and S(O)₂, wherein each of the heteroalkyl and heteroalkylene groups are unsubstituted or are substituted by one or more R^{S}.

Examples of unsubstituted (C₂-C₄₀)heterocycloalkyl include unsubstituted (C₂-C₂₀)heterocycloalkyl, unsubstituted (C₂-C₁₀)heterocycloalkyl, aziridin-1-yl, oxetan-2-yl, tetrahydrofuran-3-yl, pyrrolidin-1-yl, tetrahydrothiophen-S,S-dioxide-2-yl, morpholin-4-yl, 1,4-dioxan-2-yl, hexahydroazepin-4-yl, 3-oxa-cyclooctyl, 5-thio-cyclononyl, and 2-aza-cyclodecyl.

The term “halogen atom” or “halogen” means the radical of a fluorine atom (F), chlorine atom (Cl), bromine atom (Br), or iodine atom (I). The term “halide” means the anionic form of the halogen atom: fluoride (F⁻), chloride (Cl⁻), bromide (Br⁻), or iodide (I⁻).

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may or may not be present in substituents R^{S}. The term “unsaturated” means containing one or more carbon-carbon double bonds, carbon-carbon triple bonds, or (in heteroatom-containing groups) one or more carbon-nitrogen, carbon-phosphorous, or carbon-silicon double bonds, not including double bonds that may be present in substituents R^{S}, if any, or in (hetero) aromatic rings, if any.

Embodiments of this disclosure include processes for polymerizing olefin monomers to produce polyolefin. The process includes reacting ethylene and optionally one or more olefin monomers in the presence of a catalyst system and adjusting the hydrogen gas to tailor the molecular weight of the polyolefin.

The amount of hydrogen gas may include 0 mmol of hydrogen gas in the reactor at any given time during the polymerization reaction. The amount of hydrogen may be increased or it may be decreased as the reaction progresses. In a semi-batch polymerization process the amount of hydrogen may decrease when the polymerization reactants consume the hydrogen gas and additional hydrogen gas is not added.

The catalyst system includes one or more constrained geometry procatalysts according to formula (I) and one or more phosphinimine procatalysts according to formula (V).

Embodiments of this disclosure include catalyst systems that include one or more constrained geometry procatalysts according to formula (I):

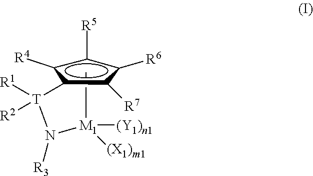

In formula (I), M₁ is titanium, zirconium, hafnium or scandium; subscript n₁ is 0, 1, 2, or 3; subscript m₁ is 0, 1, or 2 and each X₁ is a monodentate ligand independently chosen from (C₁-C₅₀)hydrocarbon, (C₁-C₅₀)heterohydrocarbon, (C₁-C₅₀)hydrocarbyl, (C₆-C₅₀)aryl, (C₆-C₅₀)heteroaryl, cyclopentadienyl, substituted cyclopentadienyl, (C₄-C₁₂)diene, halogen, hydrogen, —N(R^{N})₂, and —NCOR^{C}. The metal-ligand complex is overall charge-neutral.

In formula (I), N is nitrogen; T is carbon or silicon and is covalently bonded to Cp; and R¹ and R² are independently selected from —H, (C₁-C₄₀)hydrocarbyl, and (C₁-C₄₀)heterohydrocarbyl; and R³ are independently selected from (C₁-C₄₀)hydrocarbyl, and (C₁-C₄₀)heterohydrocarbyl.

In formula (I), R⁴, R⁵, R⁶, and R⁷ are independently (C₁-C₅₀)hydrocarbyl, (C₁-C₅₀)heterohydrocarbyl wherein any of the R⁴, R⁵, R⁶, and R⁷ optionally are connected to form a ring structure

In one or more embodiments, in formula (I), R¹ and R² are methyl, ethyl, propyl, or phenyl. In some embodiments, R³ is independently (C₁-C₁₂)alkyl. In various embodiments, R³ is independently tert-butyl, tert-octyl, or n-octyl.

In some embodiments, R⁶ is —OMe; or R⁵ is —NMe₂.

In some embodiment, in formula (I), (A) R⁴ and R⁵ are connected and form a ring optionally substituted by one or more R^{S}; or (B) R⁶ and R⁷ are connect and form ring optionally substituted by one or more R^{S}; or (C) both (A) and (B). Thus, when (A), (B), or (C) occurs, the cyclopentadienyl of formula (I) have a structure selected from the group consisting of:

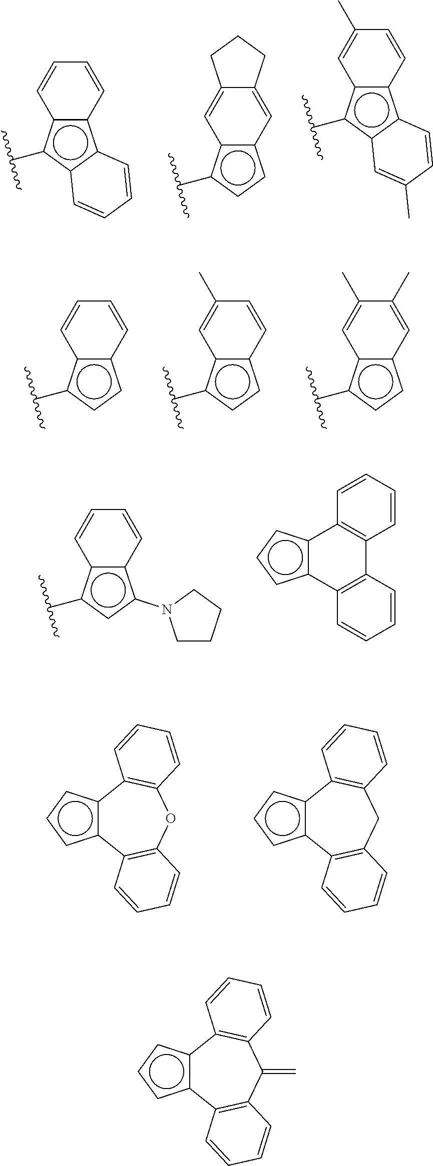

Embodiments of this disclosure include catalyst systems that include one or more phosphinimine procatalysts according to formula (V):

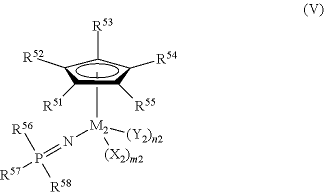

In formula (V), subscript m₂ is 0, 1, or 2; subscript n₂ is 0, 1, and 2 each Y₂ is a monodentate ligand independently chosen from (C₁-C₂₀)hydrocarbyl, (C₆-C₅₀)aryl, (C₆-C₅₀)heteroaryl, halogen, —N(R^{N})₂, and —NCOR^{C}.

In formula (IV), each X₂ is a monodentate ligand independently chosen from (C₁-C₅₀)hydrocarbyl, (C₁-C₅₀)heterohydrocarbyl, —CH₂Si(R^{C})_{3-Q}(OR^{C})_{Q}, —Si(R^{C})_{3-Q}(OR^{C})_{Q}, —OSi(R^{C})_{3-Q}(OR^{C})_{Q}, —CH₂Ge(R^{C})_{3-Q}(OR^{C})_{Q}, —Ge(R^{C})_{3-Q}(OR^{C})_{Q}, —P(R^{C})_{2-W}(OR^{C})_{W}, —P(O)(R^{C})_{2-W}(OR^{C})_{W}, —N(R^{C})₂, —NH(R^{C}), —N(Si(R^{C})₃)₂, —NR^{C}Si(R^{C})₃—NHSi(R^{C})₃, —OR^{C}, —SR^{C}, —NO₂, —CN, —CF₃, —OCF₃, —S(O)R^{C}, —S(O)₂R^{C}, —OS(O)₂R^{C}, —N═C(R^{C})₂, —N═CH(R^{C}), —N═CH₂, —N═P(R^{C})₃, —OC(O)R^{C}, —C(O)OR^{C}, —N(R^{C})C(O)R^{C}, —N(R^{C})C(O)H, —NHC(O)R^{C}, —C(O)N(R^{C})₂, —C(O)NHR^{C}, —C(O)NH₂, a halogen, B(R^{Y})₄, Al(R^{Y})₄, or Ga(R^{Y})₄, or a hydrogen, wherein each R^{C} is independently a (C₁-C₃₀)hydrocarbyl, or (C₁-C₃₀)heterohydrocarbyl, and each Q is 0, 1, 2 or 3, and each W is 0, 1, or 2; each R^{Y} is —H, (C₁-C₃₀)hydrocarbyl, or halogen atom, wherein two X₂ ligands can be connected to form a metallacycle ring.

In formula (V), each Y₂ is independently Lewis Base; optionally, X₂ and Y₂ can be linked to form a ring. Subscript m₂ is 0, 1 and 2; and subscript n₂ is 0, 1 and 2.

In formula (V), R⁵¹, R⁵², R⁵³, R⁵⁴, and R⁵⁵ are independently (C₁-C₅₀)hydrocarbyl, wherein R⁵¹ and R⁵² are optionally connected to form a ring, or R⁵² and R⁵³ are optionally connected to form a ring, R⁵³ and R⁵⁴ are optionally connected to form a ring, R⁵⁴ and R⁵⁵ optionally are connected to form a ring;

In formula (V), R⁵⁶, R⁵⁷, and R⁵⁸ are independently (C₁-C₂₀)hydrocarbyl, (C₁-C₂₀)heterohydrocarbyl, (C₆-C₃₀)aryl, (C₅-C₃₀)heteroaryl wherein two of R⁵⁶, R⁵⁷, and R⁵ are optionally connected to form a ring.

In formulas (I), (II), (III), (IV), and (V), each R^{C}, R, and R^{N} in formula (I) is independently a (C₁-C₃₀)hydrocarbyl, (C₁-C₃₀)heterohydrocarbyl, or —H.

In one or more embodiments, in formula (V), R⁶⁶, R⁶⁷, R⁶⁸ are independently (C₁-C₂₀)alkyl.

In some embodiments, in formula (V), R⁶⁶, R⁶⁷, R⁶⁸ are independently selected from the group consisting of: methyl, ethyl, 1-propyl, 2-propyl (also called iso-propyl), 1,1-dimethylethyl (also called tert-butyl), cyclopentyl, cyclohexyl, 1-butyl, pentyl, 3-methylbutyl, hexyl, 4-methylpentyl, heptyl, n-octyl, tert-octyl (also called 2,4,4-trimethylpentan-2-yl), nonyl, and decyl.

In various embodiments, in formula (V), wherein R⁵⁴ and R⁵⁵ are connected to form an aromatic ring.

In one or more embodiments, in formula (V), R⁵¹, R⁵², R⁵³, R⁵⁴, and R⁵⁵ are (C₁-C₃)alkyl; or R⁵¹, R⁵², and R⁵⁴ are (C₁-C₃)alkyl, or R⁵¹ and R⁵³ are (C₁-C₃)alkyl.

In some embodiments, in formula (V) one of R⁵¹, R⁵², R⁵³, R⁵⁴, and R⁵⁵ is selected from —OMe and —NMe₂.

In various embodiments, in formula (V), (A) R⁵¹ and R⁵² are connected and form a ring and are optionally substituted by one or more R^{S}; or (B) R⁵³ and R⁵⁴ are connected and form a ring and are optionally substituted by one or more R^{S}; or (C) both (A) and (B). Thus, when (A), (B), or (C) occur, the cyclopentadienyl of formula (V) have a structure selected from the group consisting of:

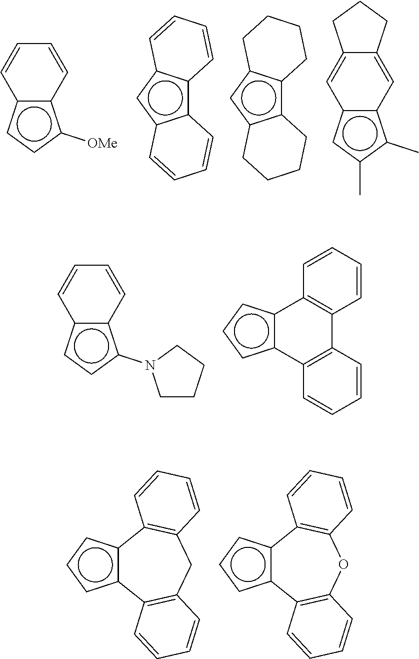

In some embodiments, the monodentate ligand, X₁ of formula (I) and X₂ of formula (V) may be a monoanionic ligand. Monoanionic ligands have a net formal oxidation state of −1. Each monoanionic ligand may independently be hydride, (C₁-C₄₀)hydrocarbyl carbanion, (C₁-C₄₀)heterohydrocarbyl carbanion, halide, nitrate, carbonate, phosphate, sulfate, HC(O)O—, HC(O)N(H)⁻, (C₁-C₄₀)hydrocarbylC(O)O⁻, (C₁-C₄₀)hydrocarbylC(O)N((C₁-C₂₀)hydrocarbyl)⁻, (C₁-C₄₀)hydrocarbylC(O)N(H)⁻, R^{K}R^{L}B⁻, R^{K}R^{L}N⁻, R^{K}O⁻, R^{K}S⁻, R^{K}R^{L}P⁻, or R^{M}R^{K}R^{L}Si⁻, where each R^{K}, R^{L}, and R^{M} independently is hydrogen, (C₁-C₄₀)hydrocarbyl, or (C₁-C₄₀)heterohydrocarbyl, or R^{K} and R^{L} are taken together to form a (C₂-C₄₀)hydrocarbylene or (C₁-C₂₀)heterohydrocarbylene and R^{M} is as defined above.

In other embodiments, at least one monodentate ligand X₁, independently from any other ligands X₁, and X₂ of formula (V), independent from other ligand X₂, may be a neutral ligand. In specific embodiments, the neutral ligand is a neutral Lewis base group such as R^{Q}NR^{K}R^{L}, R^{K}OR^{L}, R^{K}SR^{L}, or R^{Q}PR^{K}R^{L}, where each R^{Q} independently is hydrogen, [(C₁-C₁₀)hydrocarbyl]₃Si(C₁-C₁₀)hydrocarbyl, (C₁-C₄₀)hydrocarbyl, [(C₁-C₁₀)hydrocarbyl]₃Si, or (C₁-C₄₀)heterohydrocarbyl and each R^{K} and R^{L} independently is as previously defined.

In the metal-ligand complex according to formulas (I) and (V), each Y₁ may bond with M₁ through a dative bond or an ionic bond and each Y₂ may bond with M₂ through a dative bond or an ionic bond. In one or more embodiments, Y₁ or Y₂ is a Lewis base. The Lewis base may be a compound or an ionic species, which can donate an electron pair to an acceptor compound. For purposes of this description, the acceptor compound is M₁ or M₂ the metal of the metal-ligand complex of formulas (I) and (V). The Lewis base may be neutral or anionic. In some embodiments, the Lewis base may be a heterohydrocarbon or an unsaturated hydrocarbon. Examples of neutral heterohydrocarbon Lewis bases includes, but are not limited to, amines, trialkylamines, ethers, cycloethers, or sulfides. An example of anionic hydrocarbon includes, but is not limited to, cyclopentadienyl. An example of a neutral hydrocarbon Lewis Base includes, but is not limited to, 1,3-buta-di-ene.

In some embodiments, the Lewis base is (C₁-C₂₀)hydrocarbon. In some embodiments, the Lewis base is cyclopentadiene or 1,3-buta-di-ene. In various embodiments, the Lewis base is (C₁-C₂₀)heterohydrocarbon, wherein the hetero atom of the heterohydrocarbon is oxygen. In some embodiments, Y₁ or Y₂ is tetrahydrofuran, diethyl ether, or methyl tert-butyl ether (MTBE).

Additionally, each X₂ and each Y₂ can be a monodentate ligand that, independently from any other ligands X₂ and Y₂, is a halogen, unsubstituted (C₁-C₂₀)hydrocarbyl, unsubstituted (C₁-C₂₀)hydrocarbylC(O)O—, or R^{K}R_{L}N—, wherein each of R^{K} and R^{L} independently is an unsubstituted(C₁-C₂₀)hydrocarbyl. In some embodiments, each monodentate ligand X₁ is a chlorine atom, (C₁-C₁₀)hydrocarbyl (e.g., (C₁-C₆)alkyl or benzyl), unsubstituted (C₁-C₁₀)hydrocarbylC(O)O—, or R^{K}R^{L}N—, wherein each of R^{K} and R^{L} independently is an unsubstituted (C₁-C₁₀)hydrocarbyl.

In one or more embodiments of formulas (I) and (V), X₁ and X₂ is (C₁-C₂₀)hydrocarbyl or (C₁-C₁₀)hydrocarbyl, (C₁-C₂₀)heterohydrocarbyl or (C₁-C₁₀)heterohydrocarbyl. In some embodiments, in formulas (I) and (V), X₁ and X₂ is (C₁-C₂₀)aryl or (C₁-C₂₀)heteraryl.

In one or more embodiments, in formulas (I) and (V), X₁ and X₂ is benzyl, chloro, —CH₂SiMe₃, or phenyl.

In various embodiments, each X₁ is selected from methyl; ethyl; 1-propyl; 2-propyl; 1-butyl; 2,2-dimethylpropyl; trimethylsilylmethyl; phenyl; benzyl; or chloro. In some embodiments, each X₁ is the same. In other embodiments, at least two X₁ are different from each other. In the embodiments in which at least two X₁ are different from at least one X₁, X₁ is a different one of methyl; ethyl; 1-propyl; 2-propyl; 1-butyl; 2,2,-dimethylpropyl; trimethylsilylmethyl; phenyl; benzyl; and chloro. In further embodiments, the bidentate ligand is 2,2-dimethyl-2-silapropane-1,3-diyl or 1,3-butadiene.

In further embodiments, each X₂ is selected from methyl; ethyl; 1-propyl; 2-propyl; 1-butyl; 2,2-dimethylpropyl; trimethylsilylmethyl; phenyl; benzyl; or chloro. In some embodiments, each X₂ is the same. In other embodiments, at least two X₂ are different from each other. In the embodiments in which at least two X₂ are different from at least one X₂, X₂ is a different one of methyl; ethyl; 1-propyl; 2-propyl; 1-butyl; 2,2,-dimethylpropyl; trimethylsilylmethyl; phenyl; benzyl; and chloro. In further embodiments, the bidentate ligand is 2,2-dimethyl-2-silapropane-1,3-diyl or 1,3-butadiene.

In some embodiments, any or all of the chemical groups (e.g., X, X₂ and R¹-R⁴) of the metal-ligand complex of formula (I) may be unsubstituted. In other embodiments, none, any, or all of the chemical groups X₁, X₂ and R¹-R⁴ of the metal-ligand complex of formula (I) may be substituted with one or more than one R^{S}. When two or more than two R^{S} are bonded to a same chemical group of the metal-ligand complex of formula (I), the individual R^{S} of the chemical group may be bonded to the same carbon atom or heteroatom or to different carbon atoms or heteroatoms. In some embodiments, none, any, or all of the chemical groups X₁, X₂ and R¹-R⁴ may be persubstituted with R^{S}. In the chemical groups that are persubstituted with R^{S}, the individual R^{S} may all be the same or may be independently chosen.

In some embodiments, the ratio of hydrogen chain transfer constants for the procatalyst for formula (V) to the procatalyst of formula (I) is greater than or equal to 3 at 160° C. In other embodiments, the ratio of hydrogen chain transfer constants for the procatalyst of formula (v) to the procatalyst of formula (I) is greater than or equal to 5 at 160° C.; greater than or equal to 7 at 160° C.; or greater than or equal to 10 at 160° C.; or greater than or equal to 20 at 160° C.

In illustrative embodiments, the catalyst systems may include a metal-ligand complex according to formula (I) having the structure of any of the procatalyst CGC-1 and metal-ligand complex according to formula (V) having the structure of any of procatalysts PN-1 to PN-3:

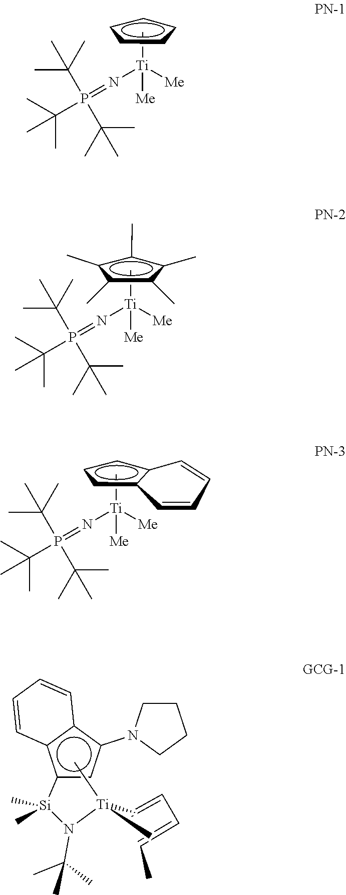

### Cocatalyst Component

The catalyst system comprising a metal-ligand complex of formula (I) may be rendered catalytically active by any technique known in the art for activating metal-based catalysts of olefin polymerization reactions. For example, the procatalyst according to a metal-ligand complex of formula (I) may be rendered catalytically active by contacting the complex to, or combining the complex with, an activating co-catalyst. Additionally, the metal-ligand complex according for formula (I) includes both a procatalyst form, which is neutral, and a catalytic form, which may be positively charged due to the loss of a monoanionic ligand, such a benzyl or phenyl. Suitable activating co-catalysts for use herein include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). A suitable activating technique is bulk electrolysis. Combinations of one or more of the foregoing activating co-catalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

In some embodiments, the catalyst system does not include additives. An additive is a chemical agent present during the polymerization reaction the does not deter olefin propagation. In one or more embodiments, the catalyst system further comprises an additive. In some embodiments, the additives function as a co-catalyst. In other embodiments, the additives function as a scavenger or scavenging agent. A co-catalyst is a reagent that reacts in cooperation with a catalyst to catalyze the reaction or improve the catalytic activity of the catalyst.

A scavenging agent sequesters impurities in the reactor prior to addition of the procatalyst, and as such, does not constitute and activator. Lower loading of alumoxanes do not act as co-catalysts, rather they serve as scavenging agent.

Suitable additives may include, but are not limited to, alkyl aluminums; polymeric or oligomeric alumoxanes (also known as aluminoxanes); neutral Lewis acids; and non-polymeric, non-coordinating, ion-forming compounds (including the use of such compounds under oxidizing conditions). Combinations of one or more of the foregoing additives and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

Lewis acid activating co-catalysts include Group 13 metal compounds containing (C₁-C₂₀)hydrocarbyl substituents as described herein. In some embodiments, Group 13 metal compounds are tri((C₁-C₂₀)hydrocarbyl)-substituted-aluminum or tri((C₁-C₂₀)hydrocarbyl)-boron compounds. In other embodiments, Group 13 metal compounds are tri(hydrocarbyl)-substituted-aluminum, tri((C₁-C₂₀)hydrocarbyl)-boron compounds, tri((C₁-C₁₀)alkyl)aluminum, tri((C₆-C₁₈)aryl)boron compounds, and halogenated (including perhalogenated) derivatives thereof. In further embodiments, Group 13 metal compounds are tris(fluoro-substituted phenyl)boranes, tris(pentafluorophenyl)borane. In some embodiments, the activating co-catalyst is a tris((C₁-C₂₀)hydrocarbyl borate (e.g. trityl tetrafluoroborate) or a tri((C₁-C₂₀)hydrocarbyl)ammonium tetra((C₁-C₂₀)hydrocarbyl)borane (e.g. bis(octadecyl)methylammonium tetrakis(pentafluorophenyl)borane). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₀)hydrocarbyl, when two or more are present, may be the same or different.

Combinations of neutral Lewis acid activating co-catalysts include mixtures comprising a combination of a tri((C₁-C₄)alkyl)aluminum and a halogenated tri((C₆-C₁₈)aryl)boron compound, especially a tris(pentafluorophenyl)borane. Other embodiments are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Ratios of numbers of moles of (metal-ligand complex):(tris(pentafluoro-phenylborane):(alumoxane) [e.g., (Group 4 metal-ligand complex):(tris(pentafluoro-phenylborane):(alumoxane)] are from 1:1:1 to 1:10:30, in other embodiments, from 1:1:1.5 to 1:5:10.

The catalyst system that includes the metal-ligand complex of formula (I) may be activated to form an active catalyst composition by combination with one or more cocatalysts, for example, a cation forming cocatalyst, a strong Lewis acid, or combinations thereof. Suitable activating co-catalysts include polymeric or oligomeric aluminoxanes, especially methyl aluminoxane, as well as inert, compatible, noncoordinating, ion forming compounds. Exemplary suitable co-catalysts include, but are not limited to modified methyl aluminoxane (MMAO), bis(hydrogenated tallow alkyl)methyl, tetrakis(pentafluorophenyl)borate(1-)amine, and combinations thereof.

In some embodiments, more than one of the previously mentioned activating co-catalysts may be used in combination with each other. A specific example of a co-catalyst combination is a mixture of a tri((C₁-C₄)hydrocarbyl)aluminum, tri((C₁-C₄)hydrocarbyl)borane, or an ammonium borate with an oligomeric or polymeric alumoxane compound. The ratio of total number of moles of one or more metal-ligand complexes of formula (I) to total number of moles of one or more of the activating co-catalysts is from 1:10,000 to 100:1. In some embodiments, the ratio is at least 1:5000, in some other embodiments, at least 1:1000; and 10:1 or less, and in some other embodiments, 1:1 or less. When an alumoxane alone is used as the activating co-catalyst, preferably the number of moles of the alumoxane that are employed is at least 100 times the number of moles of the metal-ligand complex of formula (I). When tris(pentafluorophenyl)borane alone is used as the activating co-catalyst, in some other embodiments, the number of moles of the tris(pentafluorophenyl)borane that are employed to the total number of moles of one or more metal-ligand complexes of formula (I) from 0.5:1 to 10:1, from 1:1 to 6:1, or from 1:1 to 5:1. The remaining activating co-catalysts are generally employed in approximately mole quantities equal to the total mole quantities of one or more metal-ligand complexes of formula (I).

### Polymerization Process

Any conventional polymerization processes may be employed to produce the polyolefin composition according to the present disclosure. Such conventional polymerization processes include, but are not limited to, solution polymerization process, particle forming polymerization process, and combinations thereof using one or more conventional reactors e.g. loop reactors, isothermal reactors, fluidized bed reactors, stirred tank reactors, batch reactors in parallel, series, and/or any combinations thereof.

In one embodiment, the polyolefin composition according to the present disclosure may, for example, be produced via solution-phase polymerization process using one or more loop reactors, isothermal reactors, and combinations thereof.

In general, the solution phase polymerization process occurs in one or more well-stirred reactors such as one or more loop reactors or one or more spherical isothermal reactors at a temperature in the range of from 120° C. to 300° C.; from 120° C. to 250° C.; from 150 to 300° C.; from 150° C. to 250° C.; or from 160° C. to 215° C., and at pressures in the range of from 300 to 1500 psi; for example, from 400 to 750 psi. The residence time in solution phase polymerization process is typically in the range of from 2 to 30 minutes; for example, from 5 to 15 minutes. Ethylene, one or more solvents, one or more high temperature olefin polymerization catalyst systems, one or more cocatalysts and/or scavengers, and optionally one or more comonomers are fed continuously to the one or more reactors. Exemplary solvents include, but are not limited to, isoparaffins. For example, such solvents are commercially available under the name ISOPAR E from ExxonMobil Chemical Co., Houston, Texas. The resultant mixture of the ethylene-based polymer and solvent is then removed from the reactor and the ethylene-based polymer is isolated. Solvent is typically recovered via a solvent recovery unit, i.e. heat exchangers and vapor liquid separator drum, and is then recycled back into the polymerization system.

In one embodiment, the ethylene-based polymer may be produced via solution polymerization in a single reactor system, for example a single loop reactor system, wherein ethylene and optionally one or more α-olefins are polymerized in the presence of one or more high temperature olefin polymerization catalyst systems, optionally one or more other catalysts, and optionally one or more cocatalysts. In one embodiment, the ethylene-based polymer may be produced via solution polymerization in a dual reactor system, for example a dual loop reactor system, wherein ethylene and optionally one or more α-olefins are polymerized in the presence of one or more an olefin polymerization catalyst systems, optionally one or more other catalysts, and optionally one or more cocatalysts. In one embodiment, the ethylene-based polymer may be produced via solution polymerization in a dual reactor system, for example a dual loop reactor system, wherein ethylene and optionally one or more α-olefins are polymerized in the presence of one or more high temperature olefin polymerization catalyst systems, as described herein, in both reactors.

### Polyolefins

The catalytic systems described in the preceding paragraphs are utilized in the polymerization of olefins, primarily ethylene and propylene. In some embodiments, there is only a single type of olefin or α-olefin in the polymerization scheme, creating a homopolymer. However, additional α-olefins may be incorporated into the polymerization procedure. The additional α-olefin co-monomers typically have no more than 20 carbon atoms. For example, the α-olefin co-monomers may have 3 to 10 carbon atoms or 3 to 8 carbon atoms. Exemplary α-olefin co-monomers include, but are not limited to, propylene, 1-butene, 1-pentene, 1-hexene, 1-heptene, 1-octene, 1-nonene, 1-decene, and 4-methyl-1-pentene. For example, the one or more α-olefin co-monomers may be selected from the group consisting of propylene, 1-butene, 1-hexene, and 1-octene; or in the alternative, from the group consisting of 1-hexene and 1-octene.

The ethylene based polymers, for example homopolymers and/or interpolymers (including copolymers) of ethylene and optionally one or more co-monomers such as α-olefins, may comprise from at least 50 percent by weight monomer units derived from ethylene. All individual values and subranges encompassed by “from at least 50 weight percent” are disclosed herein as separate embodiments; for example, the ethylene based polymers, homopolymers and/or interpolymers (including copolymers) of ethylene and optionally one or more co-monomers such as α-olefins may comprise at least 60 weight percent monomer units derived from ethylene; at least 70 weight percent monomer units derived from ethylene; at least 80 weight percent monomer units derived from ethylene; or from 50 to 100 weight percent monomer units derived from ethylene; or from 80 to 100 weight percent units derived from ethylene.

In some embodiments, the ethylene based polymers may comprise at least 90 mole percent units derived from ethylene. All individual values and subranges from at least 90 mole percent are included herein and disclosed herein as separate embodiments. For example, the ethylene based polymers may comprise at least 93 mole percent units derived from ethylene; at least 96 mole percent units; at least 97 mole percent units derived from ethylene; or in the alternative, from 90 to 100 mole percent units derived from ethylene; from 90 to 99.5 mole percent units derived from ethylene; or from 97 to 99.5 mole percent units derived from ethylene.

In some embodiments of the ethylene based polymer, the amount of additional α-olefin is less than 50%; other embodiments include at least 0.5 mole percent (mol %) to 25 mol %; and in further embodiments the amount of additional α-olefin includes at least 5 mol % to 10 mol %. In some embodiments, the additional α-olefin is 1-octene.

Any conventional polymerization processes may be employed to produce the ethylene based polymers. Such conventional polymerization processes include, but are not limited to, solution polymerization processes, gas phase polymerization processes, slurry phase polymerization processes, and combinations thereof using one or more conventional reactors such as loop reactors, isothermal reactors, fluidized bed gas phase reactors, stirred tank reactors, batch reactors in parallel, series, or any combinations thereof, for example.

In one embodiment, the ethylene based polymer may be produced via solution polymerization in a dual reactor system, for example a dual loop reactor system, wherein ethylene and optionally one or more α-olefins are polymerized in the presence of the catalyst system, as described herein, and optionally one or more co-catalysts. In another embodiment, the ethylene based polymer may be produced via solution polymerization in a dual reactor system, for example a dual loop reactor system, wherein ethylene and optionally one or more α-olefins are polymerized in the presence of the catalyst system in this disclosure, and as described herein, and optionally one or more other catalysts. The catalyst system, as described herein, can be used in the first reactor, or second reactor, optionally in combination with one or more other catalysts. In one embodiment, the ethylene based polymer may be produced via solution polymerization in a dual reactor system, for example a dual loop reactor system, wherein ethylene and optionally one or more α-olefins are polymerized in the presence of the catalyst system, as described herein, in both reactors.

In another embodiment, the ethylene based polymer may be produced via solution polymerization in a single reactor system, for example a single loop reactor system, in which ethylene and optionally one or more α-olefins are polymerized in the presence of the catalyst system, as described within this disclosure, and optionally one or more cocatalysts, as described in the preceding paragraphs.

The ethylene based polymers may further comprise one or more additives. Such additives include, but are not limited to, antistatic agents, color enhancers, dyes, lubricants, pigments, primary antioxidants, secondary antioxidants, processing aids, UV stabilizers, and combinations thereof. The ethylene based polymers may contain any amounts of additives. The ethylene based polymers may compromise from about 0 to about 10 percent by the combined weight of such additives, based on the weight of the ethylene based polymers and the one or more additives. The ethylene based polymers may further comprise fillers, which may include, but are not limited to, organic or inorganic fillers. The ethylene based polymers may contain from about 0 to about 20 weight percent fillers such as, for example, calcium carbonate, talc, or Mg(OH)₂, based on the combined weight of the ethylene based polymers and all additives or fillers. The ethylene based polymers may further be blended with one or more polymers to form a blend.

In some embodiments, a polymerization process for producing an ethylene-based polymer may include polymerizing ethylene and at least one additional α-olefin in the presence of a catalyst system, wherein the catalyst system incorporates at least one metal-ligand complex of formula (I). The polymer resulting from such a catalyst system that incorporates the metal-ligand complex of formula (I) may have a density according to ASTM D792 (incorporated herein by reference in its entirety) from 0.850 g/cm³ to 0.960 g/cm³, from 0.880 g/cm³ to 0.920 g/cm³, from 0.880 g/cm³ to 0.910 g/cm³, or from 0.880 g/cm³ to 0.900 g/cm³, for example.

In another embodiment, the polymer resulting from the catalyst system that includes the metal-ligand complex of formula (I) has a melt flow ratio (I₁₀/I₂) from 5 to 20, in which melt index 12 is measured according to ASTM D1238 (incorporated herein by reference in its entirety) at 190° C. and 2.16 kg load, and melt index I₁₀ is measured according to ASTM D1238 at 190° C. and 10 kg load. In other embodiments the melt flow ratio (I₁₀/I₂) is from 5 to 10, and in others, the melt flow ratio is from 5 to 9.

In some embodiments, the polymer resulting from the catalyst system that includes the metal-ligand complex of formula (I) has a molecular-weight distribution (MWD) from 1 to 25, where MWD is defined as Mw/Mn with MW being a weight-average molecular weight and Mnbeing a number-average molecular weight. In other embodiments, the polymers resulting from the catalyst system have a MWD from 1 to 6. Another embodiment includes a MWD from 1 to 3; and other embodiments include MWD from 1.5 to 2.5.

Embodiments of the catalyst systems described in this disclosure yield unique polymer properties as a result of the high molecular weights of the polymers formed and the amount of the co-monomers incorporated into the polymers.

All solvents and reagents are obtained from commercial sources and used as received unless otherwise noted. Anhydrous toluene, hexanes, tetrahydrofuran, and diethyl ether are purified via passage through activated alumina and, in some cases, Q-5 reactant. Solvents used for experiments performed in a nitrogen-filled glovebox are further dried by storage over activated 4A molecular sieves. Glassware for moisture-sensitive reactions is dried in an oven overnight prior to use. NMR spectra are recorded on Varian 400-MR and VNMRS-500 spectrometers. LC-MS analyses are performed using a Waters e2695 Separations Module coupled with a Waters 2424 ELS detector, a Waters 2998 PDA detector, and a Waters 3100 ESI mass detector. LC-MS separations are performed on an XBridge C18 3.5 μm 2.1×50 mm column using a 5:95 to 100:0 acetonitrile to water gradient with 0.1% formic acid as the ionizing agent. HRMS analyses are performed using an Agilent 1290 Infinity LC with a Zorbax Eclipse Plus C18 1.8 μm 2.1×50 mm column coupled with an Agilent 6230 TOF Mass Spectrometer with electrospray ionization. ¹H NMR data are reported as follows: chemical shift (multiplicity (br=broad, s=singlet, d=doublet, t=triplet, q=quartet, p=pentet, sex=sextet, sept=septet and m=multiplet), integration, and assignment). Chemical shifts for ¹H NMR data are reported in ppm downfield from internal tetramethylsilane (TMS, 6 scale) using residual protons in the deuterated solvent as references. ¹³C NMR data are determined with ¹H decoupling, and the chemical shifts are reported downfield from tetramethylsilane (TMS, 6 scale) in ppm versus the using residual carbons in the deuterated solvent as references.

### Compositional Conventional GPC

The chromatographic system consisted of a PolymerChar GPC-IR (Valencia, Spain) high temperature GPC chromatograph equipped with an internal IR5 infra-red detector (IR5). The autosampler oven compartment was set at 1600 Celsius and the column compartment was set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)).:

$${M}_{polyethylene} = A \times {( {M}_{polystyrene} )}^{B} \qquad ( Equation 1 )$$

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 1600 Celsius under “low speed” shaking.

The calculations of Mn(GPc), Mw(GPc), and Mz(GPC) were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( Equation 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( Equation 3 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( Equation 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

$$( Equation 5 )$$

$${Flowrate}_{( effective )} = {Flowrate}_{( nominal )} * ( {RV}_{( FM Calibrated )} / {RV}_{( FM Sample )} )$$

### Compositional Conventional UHMW GPC

The chromatographic system consisted of a PolymerChar GPC-IR (Valencia, Spain) high temperature GPC chromatograph equipped with an internal IR5 infra-red detector (IR5). The autosampler oven compartment was set at 1650 Celsius and the column compartment and detectors were set at 1550 Celsius. The columns used were 4 TOSOH TSKgel GMHHR-H (30) HT 30-micron particle size, mixed pore size columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. Individually prepared polystyrene standards of 10,000,000 and 15,000,000 g/mol, both from Agilent Technologies, were also prepared, at 0.5 and 0.3 mg/mL respectively. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)).

A third order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane which was introduced into blank sample via a micropump controlled with the PolymerChar GPC-IR system. The plate count for the chromatographic system should be greater than 12,000 for the 4 TOSOH TSKgel GMHHR-H (30) HT 30-micron particle size, mixed pore size columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn(GPC), Mw(GPC), and Mz(GPC) were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

### IR5 GPC Octene Composition Calibration

A calibration for the IR5 detector rationing was performed using at least ten ethylene-based polymer standards (Octene as comonomer) made by single-site metallocene catalyst from a single reactor in solution process (polyethylene homopolymer and ethylene/octene copolymers) of a narrow SCB distribution and known comonomer content (as measured by ¹³C NMR Method, Qiu et al., Anal. Chem.2009, 81, 8585-8589), ranging from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table A.

TABLE A
Copolymer Standards

| Wt % | IR5 Area | SCB/1000 | | |
|---|---|---|---|---|
| Comonomer | ratio | Total C | Mw | Mw/Mn |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

### Chain Transfer Constant Calculations

Chain transfer constant were calculated using the version of the Mayo equation shown in Equation 7 where Mno is the Mn without any hydrogen added to the reactor, the H₂ and ethylene concentrations are liquid phase concentrations, and ccm is the ratio of the hydrogenolysis rate constant over the propagation rate constant. The reactor volume was 3.414 L, the liquid phase ethylene concentration was estimated to be 0.539 M, and the estimated hydrogen concentrations are: 1.17 mM, 2.31 mM, 4.53 mM, 8.74 mM, amd 16.3 mM for 10, 20, 40, 80, and 160 mmol H₂, respectively. The Mn values were calculated using Equation 7 for each loading of hydrogen. The Solver feature of MS Excel was used to vary the value of ccm to minimize the sum of the squared deviations of the calculated Mn values versus the experimental Mn values for all the hydrogen loadings simultaneously.

$$\frac{1}{Mn} = \frac{1}{{Mn}_{0}} + {C}_{CTH} \frac{[ {H}_{2} ]}{28 \times [ ethylene ]} \qquad Equation 7$$

### Batch Reactor Polymerization Procedure

Raw materials (ethylene, 1-octene) and the process solvent (a narrow boiling range high-purity isoparaffinic solvent trademarked ISOPAR E commercially available from ExxonMobil Corporation) are purified with molecular sieves before introduction into the reaction environment. A one gallon (3.79 L) stirred autoclave reactor was charged with ISOPAR E, and 1-octene. The reactor was then heated to the desired temperature and charged with ethylene to reach the desired pressure. Hydrogen was also added at this point if desired. The catalyst composition was prepared in a drybox under inert atmosphere by mixing the desired pro-catalyst and optionally one or more addtives as desired, with additional solvent to give a total volume of about 15-20 mL. The activated catalyst mixture was then quick-injected into the reactor. The reactor pressure and temperature were kept constant by feeding ethylene during the polymerization and cooling the reactor as needed. After 10 minutes, the ethylene feed was shut off and the solution transferred into a nitrogen-purged resin kettle. The polymer was thoroughly dried in a vacuum oven, and the reactor was thoroughly rinsed with hot ISOPAR E between polymerization runs.

### EXAMPLES

The results of the polymerization reactions of Procatalysts PN-1, PN-2, or PN-3 in combination with CGC-1 are tabulated and discussed. One or more features of the present disclosure are illustrated in view of the examples as follows:

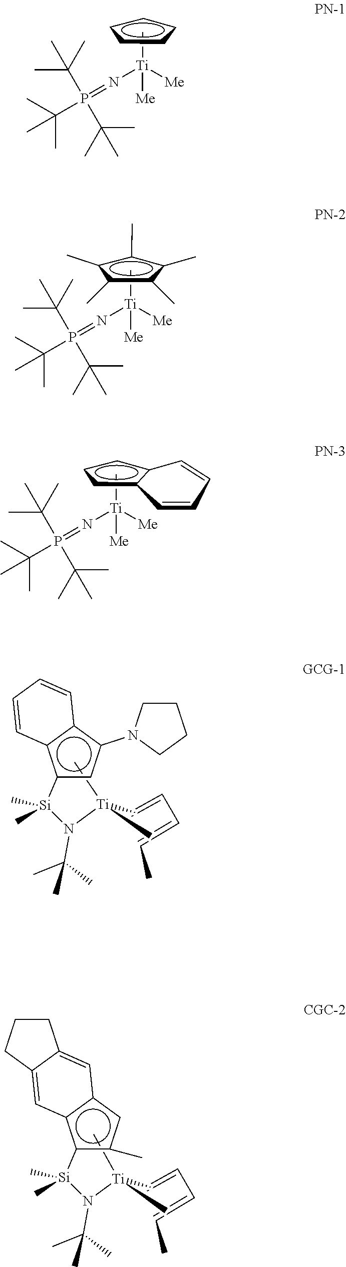

Polymerization conditions: 3.79 L (1 Gal) batch reactor, 1250 g of Isopar-E; procatalyst:activator=1:1.2; activator: ([HNMe(C₁₈H₃₇)₂][B(C₆F₅)₄]); 50 equiv of MMAO-3A; 160° C., 60 g 1-octene; ethylene, pressure to reach 320 psi, reaction time 10 min.

TABLE 1
Change of Weight Average Molecular Weight with
the incorporation of Hydrogen Gas at 160° C.

| | M_{w} at 0 | | M_{w} at 20 | M_{w} at 40 | M_{w} at 80 | M_{w} at 160 |
|---|---|---|---|---|---|---|
| | mmol of | M_{w} at 10 | mmol of | mmol of | mmol of | mmol of |
| | H₂ | mmol H₂ | H₂ | H₂ | H₂ | H₂ |
| Catalyst | (g/mol) | (g/mol) | (g/mol) | (g/mol) | (g/mol) | (g/mol) |
| PN-1 | 522,700 | 47,210 | 19,560 | 10,340 | 5,430 | 2,970 |
| PN-2 | 407,000 | 14,820 | 9,000 | 4,930 | 1,550 | 1,790 |
| PN-3 | 403,900 | 27,770 | 16,010 | 9,200 | 5,610 | 3,670 |
| CGC-1 | 338,100 | 204,400 | 139,900 | 92,580 | 52,230 | 28,410 |
| CGC-2 | 132,100 | 94,560 | 72,530 | 50,970 | 34,290 | 19,730 |

TABLE 2
Polymer Composition Produced by PN-1 and CGC-1
at Four different Hydrogen Loadings at 160° C.

| | | Hydrogen | Mn | Mw | Mz | | |
|---|---|---|---|---|---|---|---|
| | Catalyst(s) | Loading | (g/mol) | (g/mol) | (g/mol) | Mw/Mn | Mz/Mn |
| C1 | PN-1 | 0 mmol | 241,600 | 522,700 | 922,700 | 2.2 | 3.8 |
| C2 | CGC-1 | 0 mmol | 155,600 | 338,100 | 668,200 | 2.2 | 4.3 |
| I1 | PN-1/CGC-1 | 0 mmol | 130,800 | 368,300 | 644,800 | 2.8 | 4.9 |
| I2 | PN-1/CGC-1 | 5 mmol | 28,300 | 81,700 | 182,400 | 2.8 | 6.4 |
| I3 | PN-1/CGC-1 | 20 mmol | 11,200 | 42,690 | 184,900 | 3.8 | 16.5 |
| I4 | PN-1/CGC-1 | 40 mmol | 6,910 | 40,700 | 128,500 | 5.9 | 18.6 |

TABLE 3
Constants for Chain Transfer to Hydrogen
(cH2) for Selected Catalysts at 160° C.

| Catalyst | cH2 |
|---|---|
| PN-1 | 0.53 |
| PN-2 | 2.23 |
| PN-3 | 1.27 |
| CGC-1 | 0.027 |
| CGC-2 | 0.040 |

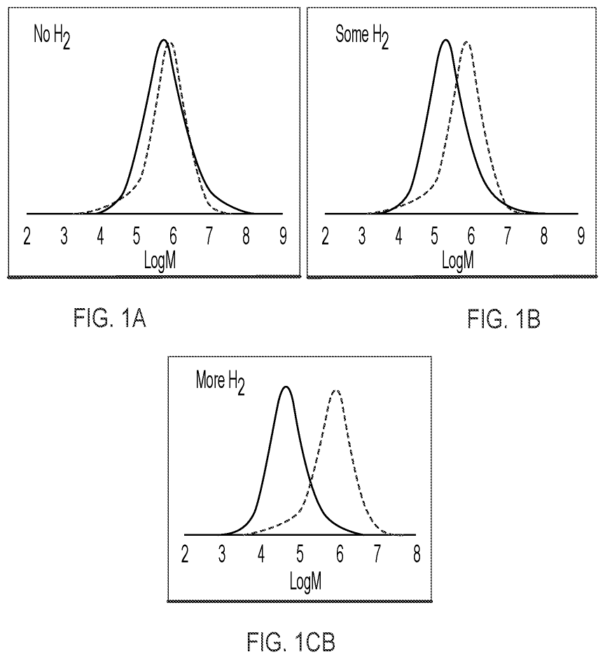

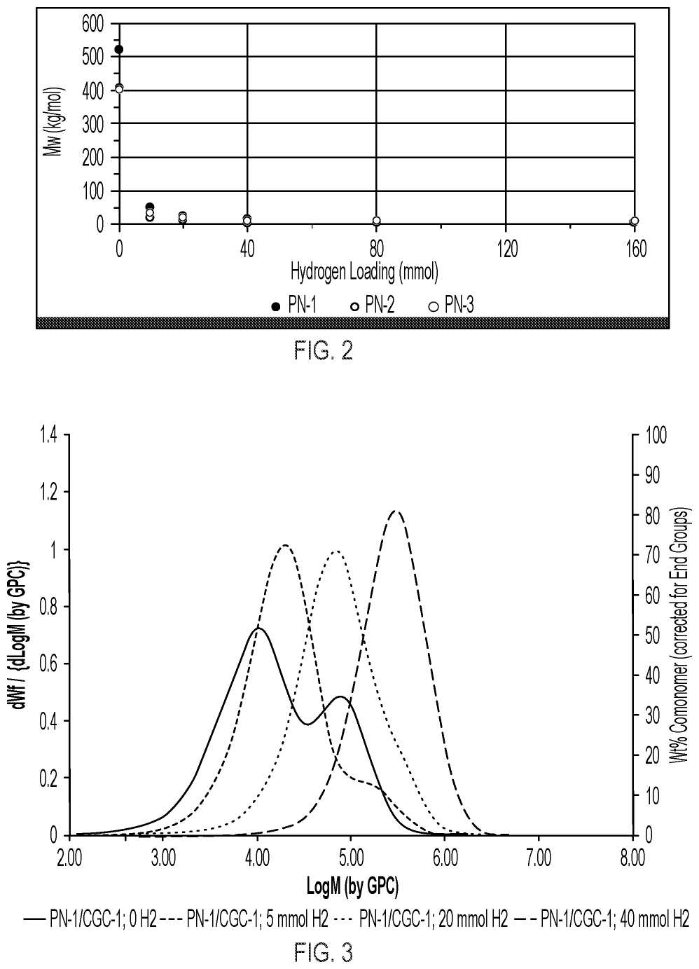

FIG. 2 demonstrated the concept that altering the hydrogen levels in the polymerization reactor alter the molecular weight of the polymer produced by the phosphinimine procatalysts. Thus, allowing the production of a bimodal polyethylene as illustrated in FIGS. 1A, 1B, and 1C.

In FIG. 3, when the amount of hydrogen in the reactor was increased, the molecular weight of the polyethylene produced by PN-1 was significantly decreased; whereas the molecular weight of the polyethylene produced CGC-1 was affected to a much smaller degree. At 0 H₂, the molecular weights of the PN-1-produced polyethylene at the CGC-1-produced polyethylene are very similar and overlap. However, as the level of H₂ was increased from 5 mmol to 20 mmol and then to 40 mmol, the molecular weight of the PN-1-produced polyethylene drops significantly, while the molecular weight of the CGC-1-produced PE was only slightly decreased, leading to the bimodality in the GPC traces in FIG. 3.

1. A process of polymerizing olefin monomers to produce polyolefin, the process comprising reacting ethylene and optionally one or more olefin monomers in one or multiple reactors in the presence of a catalyst system and optionally hydrogen gas; the catalyst system comprises two or more catalysts, at least one of which is derived from constrained geometry procatalyst according to formula (I) and at least one of which is derived from phosphinimine procatalyst according to formula (V): 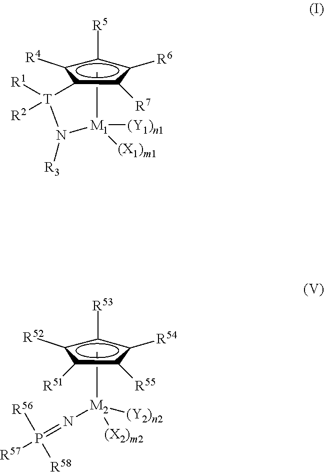
where:
M₁ is titanium, zirconium, hafnium, or scandium;
each X₁ is a monodentate ligand independently chosen from (C₁-C₅₀)hydrocarbyl, (C₁-C₅₀)heterohydrocarbyl, —CH₂Si(R^{C})_{3-Q}(OR^{C})_{Q}, —Si(R^{C})_{3-Q}(OR^{C})_{Q}, —OSi(R^{C})_{3-Q}(OR^{C})_{Q}, —CH₂Ge(R^{C})_{3-Q}(OR^{C})_{Q}, —Ge(R^{C})_{3-Q}(OR^{C})_{Q}, —P(R^{C})_{2-W}(OR^{C})_{W}, —P(O)(R^{C})_{2-W}(OR^{C})_{W}, —N(R^{C})₂, —NH(R^{C}), —N(Si(R^{C})₃)₂, —NR^{C}Si(R^{C})₃, —NHSi(R^{C})₃, —OR^{C}, —SR^{C}, —NO₂, —CN, —CF₃, —OCF₃, —S(O)R^{C}, —S(O)₂R^{C}, —OS(O)₂R^{C}, —N═C(R^{C})₂, —N═CH(R^{C}), —N═CH₂, —N═P(R^{C})₃, —OC(O)R^{C}, —C(O)OR^{C}, —N(R^{C})C(O)R^{C}, —N(R^{C})C(O)H, —NHC(O)R^{C}, —C(O)N(R^{C})₂, —C(O)NHR^{C}, —C(O)NH₂, a halogen, B(R^{Y})₄, Al(R^{Y})₄, or Ga(R^{Y})₄, or a hydrogen, wherein each R^{C} is independently a (C₁-C₃₀)hydrocarbyl, or (C₁-C₃₀)heterohydrocarbyl, and each Q is 0, 1, 2 or 3, and each W is 0, 1, or 2; each R^{Y} is —H, (C₁-C₃₀)hydrocarbyl, or halogen atom, wherein two X₁ ligands can be connected to form a metallacycle ring;
each Y₁ is independently Lewis Base; optionally, X₁ and Y₁ can be linked to form a ring;
m₁ is 1 or 2;
n₁ is 0, 1 or 2;
the procatalysts (I) and (V) are overall charge-neutral;
N is nitrogen;
T is carbon, silicon, or germanium;
R¹ and R² are independently selected from —H, (C₁-C₄₀)hydrocarbyl, and (C₁-C₄₀)heterohydrocarbyl; R¹, and R² optionally are connected to form a ring structure;
R³ are independently selected from (C₁-C₄₀)hydrocarbyl, and (C₁-C₄₀)heterohydrocarbyl;
R⁴, R⁵, R⁶, and R⁷ are independently H, (C₁-C₅₀)hydrocarbyl, (C₁-C₅₀)heterohydrocarbyl wherein any of the R⁴, R⁵, R⁶, and R⁷ optionally are connected to form one ring structure or a multi-ring structure;
M₂ is titanium, zirconium, or hafnium;
each X₂ is a monodentate ligand independently chosen from (C₁-C₅₀)hydrocarbyl, (C₁-C₅₀)heterohydrocarbyl, —CH₂Si(R^{C})_{3-Q}(OR^{C})_{Q}, —Si(R^{C})_{3-Q}(OR^{C})_{Q}, —OSi(R^{C})_{3-Q}(OR^{C})_{Q}, —CH₂Ge(R^{C})_{3-Q}(OR^{C})_{Q}, —Ge(R^{C})_{3-Q}(OR^{C})_{Q}, —P(R^{C})_{2-W}(OR^{C})_{W}, —P(O)(R^{C})_{2-W}(OR^{C})_{W}, —N(R^{C})₂, —NH(R^{C}), —N(Si(R^{C})₃)₂, —NR^{C}Si(R^{C})₃, —NHSi(R^{C})₃, —OR^{C}, —SR^{C}, —NO₂, —CN, —CF₃, —OCF₃, —S(O)R^{C}, —S(O)₂R^{C}, —OS(O)₂R^{C}, —N═C(R^{C})₂, —N═CH(R^{C}), —N═CH₂, —N═P(R^{C})₃, —OC(O)R^{C}, —C(O)OR^{C}, —N(R^{C})C(O)R^{C}, —N(R^{C})C(O)H, —NHC(O)R^{C}, —C(O)N(R^{C})₂, —C(O)NHR^{C}, —C(O)NH₂, a halogen, B(R^{Y})₄, Al(R^{Y})₄, or Ga(R^{Y})₄, or a hydrogen, wherein each R^{C} is independently a (C₁-C₃₀)hydrocarbyl, or (C₁-C₃₀)heterohydrocarbyl, and each Q is 0, 1, 2 or 3, and each W is 0, 1, or 2; each R^{Y} is —H, (C₁-C₃₀)hydrocarbyl, or halogen atom, wherein two X₂ ligands can be connected to form a metallacycle ring;
each Y₂ is independently Lewis Base; optionally, X₂ and Y₂ can be linked to form a ring.
m₂ is 1 or 2;
n₂ is 0, 1 and 2;
R⁵¹, R⁵², R⁵³, R⁵⁴, and R⁵⁵ are independently H, (C₁-C₅₀)hydrocarbyl, (C₁-C₅₀)heterohydrocarbyl wherein any of the R⁵², R⁵³, R⁵⁴, and R⁵⁵ optionally are connected to form one ring structure or a multi-ring structure;
R⁵⁶, R⁵⁷, and R⁵⁸ are independently (C₁-C₂₀)hydrocarbyl, (C₁-C₂₀)heterohydrocarbyl, (C₆-C₃₀)aryl, (C₅-C₃₀)heteroaryl wherein two of R⁵⁶, R⁵⁷, and R⁵⁸ are optionally connected to form a ring.

2. The polymerization process according to claim 1, wherein the ratio of hydrogen chain transfer constants for the procatalyst of formula (V) to the procatalyst of formula (I) is greater than or equal to 3 at 160° C.

3. The polymerization process according to claim 1, wherein R¹ and R² are methyl, ethyl, propyl, isopropyl, isobutyl, phenyl, para-tolyl.

4. The polymerization process according to claim 1, wherein R³ is independently (C₁-C₁₂)alkyl.

5. The polymerization process according to claim 1, wherein R⁴, R⁵, R⁶, and R⁷ are independently selected from the group consisting of: methyl, ethyl, 1-propyl, 2-propyl (also called iso-propyl), 1,1-dimethylethyl (also called tert-butyl), cyclopentyl, cyclohexyl, 1-butyl, pentyl, 3-methylbutyl, hexyl, 4-methylpentyl, heptyl, dimethylamino, pyrrolidino, n-octyl, tert-octyl (also called 2,4,4-trimethylpentan-2-yl), nonyl, and decyl.

6. The polymerization process according to claim 1, wherein R⁶ is —OMe; or R⁵ is —NMe₂.

7. The polymerization process according to claim 1, wherein:
(A) R⁴ and R⁵ are connected and form a ring optionally substituted by one or more R^{S}; or
(B) R⁶ and R⁷ are connect and form ring optionally substituted by one or more R^{S}; or
(C) both (A) and (B);
wherein (A), (B), or (C) and the cyclopentadienyl of formula (I) have a structure selected from the group consisting of:

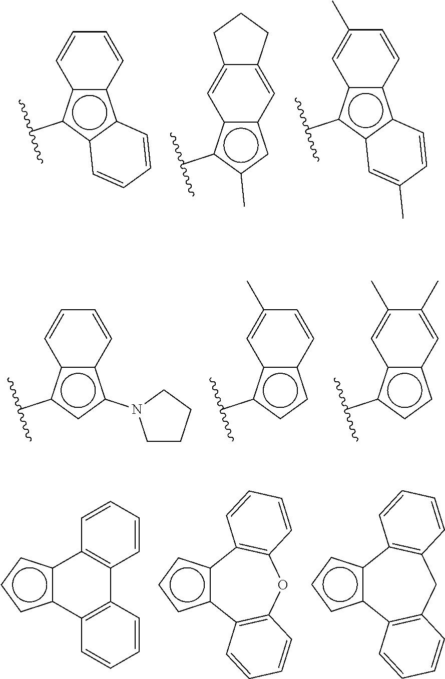

8. The polymerization process according to claim 1, wherein one of R¹, R², R⁵³, R⁵⁴, and R⁵⁵ is selected from —OMe and —NMe₂.

9. The polymerization process according to claim 1, wherein:
(A) R⁵¹ and R⁵² are connected and form a ring and are optionally substituted by one or more R^{S}; or
(B) R⁵³ and R⁵⁴ are connected and form a ring and are optionally substituted by one or more R^{S}; or
(C) both (A) and (B);
wherein (A), (B), or (C) and the cyclopentadienyl of formula (V) have a structure selected from the group consisting of:

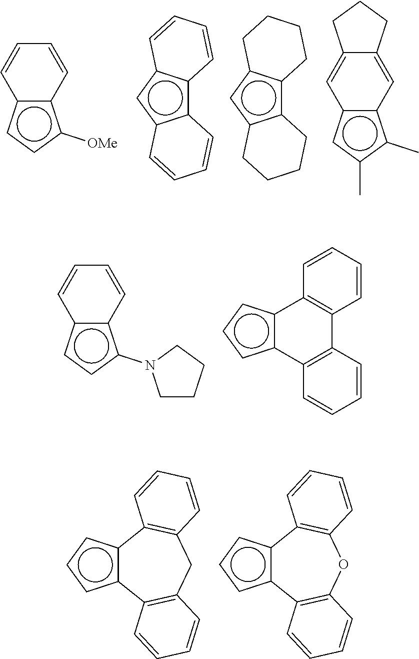

10. The polymerization process according to claim 1, wherein R⁵⁶, R⁵¹, R⁵⁸ are independently (C₁-C₂₀)alkyl.

11. The polymerization process according to claim 1, wherein R⁵⁶, R⁵⁷, R⁵⁸ are independently selected from the group consisting of: methyl, ethyl, 1-propyl, 2-propyl (also called iso-propyl), 1,1-dimethylethyl (also called tert-butyl), cyclopentyl, cyclohexyl, 1-butyl, pentyl, 3-methylbutyl, hexyl, 4-methylpentyl, dimethylamino, heptyl, n-octyl, tert-octyl (also called 2,4,4-trimethylpentan-2-yl), nonyl, and decyl.

12. The polymerization process according to claim 1, wherein R⁵¹, R⁵², R⁵³, R⁵⁴, and R⁵⁵ are independently selected from the group consisting of: methyl, ethyl, 1-propyl, 2-propyl (also called iso-propyl), 1,1-dimethylethyl (also called tert-butyl), cyclopentyl, cyclohexyl, 1-butyl, pentyl, 3-methylbutyl, hexyl, 4-methylpentyl, heptyl, dimethylamino, pyrrolidino, n-octyl, tert-octyl (also called 2,4,4-trimethylpentan-2-yl), nonyl, and decyl.

13. The polymerization process according to claim 1, wherein the polymerization process is a solution polymerization reaction.
